(19) United States
(12) Patent Application Publication
(10) Pub. No.: US 2013/0036065 A1
(43) Pub. Date: Feb. 7, 2013

(54) METHOD AND SYSTEM FOR IDENTIFYING JOB CANDIDATES, SOCIAL NETWORKS, AND RECRUITERS TO FACILITATE THE RECRUITING PROCESS

(71) Applicants: Changsheng Chen, Castro Valley, CA (US); Syed Mohammed Ali, Sunnyvale, CA (US); Adam Hyder, Los Altos, CA (US); Kam Wing Chu, Burlingame, CA (US)

(72) Inventors: Changsheng Chen, Castro Valley, CA (US); Syed Mohammed Ali, Sunnyvale, CA (US); Adam Hyder, Los Altos, CA (US); Kam Wing Chu, Burlingame, CA (US)

(73) Assignee: JOBVITE, INC., Burlingame, CA (US)

(21) Appl. No.: 13/198,316

(22) Filed: Aug. 4, 2011

(51) Int. Cl. G06Q 10/00

(52) U.S. Cl. 705/319; 705/321

(57) ABSTRACT

In general, the invention relates to a method for identifying a job candidate. The method includes determining new job characteristics for the new job using a job record corresponding to the new job, identifying an old job using the new job characteristics and old job characteristics, where the old job is similar to the new job and where a similarity between the old job and the new job is quantified using a job similarity factor. The method further includes selecting a job candidate, where the job candidate has applied for the old job, determining a candidate matching factor for the job candidate based on the old job, determining a rating for the job candidate using the job similarity factor and the candidate matching factor for the job candidate, and identifying the job candidate to contact about the job based on the rating.

### BACKGROUND

When companies are looking to hire a new employee for a job, they need to advertise the new job so that job candidates become aware of the new job opportunity and apply for the job. Companies typically advertize the new job by encouraging their employees and third parties (e.g., recruiters) to tell people they know to apply for the job. However, this ad hoc approach is traditionally inefficient—both in terms of identifying good job candidates and reaching individuals that are good job candidates.

### SUMMARY

In general, in one aspect, the invention relates to a non-transitory computer readable medium comprising instructions, which when executed by a process perform a method, the method comprising determining a plurality of new job characteristics for a new job using a job record corresponding to the new job, identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor, selecting a job candidate, wherein the job candidate has applied for the old job, determining a candidate matching factor for the job candidate based on the old job, determining a rating for the job candidate using the job similarity factor and the candidate matching factor for the job candidate, and identifying the job candidate to contact about the job based on the rating.

In general, in one aspect, the invention relates to a non-transitory computer readable medium comprising instructions, which when executed by a process perform a method, the method comprising determining a plurality of new job characteristics for a new job using a job record corresponding to the new job, selecting an employee of a company, wherein the new job is at the company, selecting a social network to which the employee belongs, identifying a job candidate, wherein the job candidate is a connected to the employee in the social network, determining a candidate similarity factor for the job candidate using the plurality of new job characteristics and a profile of the job candidate obtained from the social network, wherein the candidate similarity factor for the job candidate quantifies similarity between the profile and the plurality of new job characteristics, and sending a message to the employee based on the candidate similarity factor of the job candidate, wherein the message requests the employee to refer the new job to the job candidate.

In general, in one aspect, the invention relates to a non-transitory computer readable medium comprising instructions, which when executed by a process perform a method, the method comprising determining a plurality of new job characteristics for a new job using a job record corresponding to the new job, identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor, selecting a recruiter, wherein the recruiter was hired to locate job candidates for the old job, determining a recruiter success factor based on the old job, determining a rating for the recruiter using the job similarity factor and the recruiter success factor for the recruiter, and determining whether to hire the recruiter to locate job candidates for the new job based on the rating.

In general, in one aspect, the invention relates to a non-transitory computer readable medium comprising instructions, which when executed by a process perform a method, the method comprising determining a plurality of new job characteristics for a new job using a job record corresponding to the new job, identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor, determining a plurality of social networks over which a message for the old job was communicated to potential job candidates, wherein the message is one selected form a group consisting of a job message and a broadcast job message, determining a social network conversion rate for each of the plurality of social networks to obtain a plurality of social network conversion rates, determining a rating for each of the plurality of social networks using the job similarity factor and the plurality of social network conversion rates to obtain a plurality of ratings, and selecting at least one of the plurality of social networks over which to communicate a job message for the new job based on the plurality of ratings.

Other aspects of the invention will be apparent from the following description and the appended claims.

### BRIEF DESCRIPTION OF DRAWINGS

FIG. 1 shows a system in accordance with one or more embodiments of the invention.

FIGS. 2A-2H show data structures in accordance with one or more embodiments of the invention.

FIGS. 3A-3D show flowcharts in accordance with one or more embodiments of the invention.

FIGS. 4A-4H show examples in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to identifying job candidates or referral entities for a new job. Embodiments of the invention may also be used to identify social networks through which job candidates may be contacted. Embodiments of the invention may identify job candidates, referral entities, or social networks using job similarity factors, candidate matching factors, candidate similarity factors, social network conversion rates, and/or recruiter success factors.

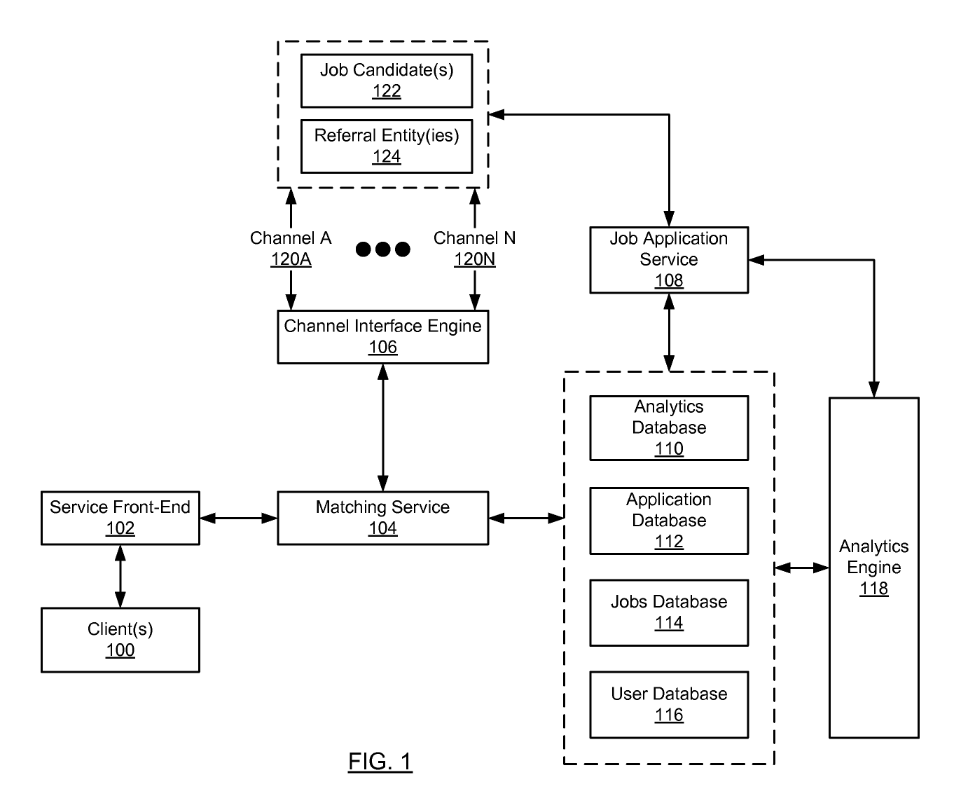

In one embodiment of the invention, jobs are communicated to job candidates and/or referral entities via job messages or broadcast job messages. In one embodiment of the invention, each job message specifies a job and is associated with a sender, a recipient, and a communication channel (described in FIG. 1). The job messages are used to directly communicate the job between individual users. In one embodiment of the invention, each broadcast job message specifies a job, a sender, and a communication channel (described in FIG. 1). The broadcast job messages are used to communicate the job concurrently to a group of individuals.

In one embodiment of the invention, a referral entity is any user that receives a job message or broadcast job message for a job and then forwards the job (via a job message or broadcast job message) to another user. The user that receives a job message or broadcast job message from a referral entity may be a job candidate, a referral entity, or both. Examples of referral entities may include, but are not limited to, recruiters hired by the company offering the job, employees of the company offering the job, individuals in a user's social network (i.e., the social network of the individual who is creating the original job message/broadcast job message or the social network of the individual who has received a job message/broadcast job message for a job and is forwarding), or any other individual that creates a job message/broadcast job message.

FIG. 1 shows a system in accordance with one or more embodiments of the invention. The system includes one or more clients (100), a service front-end (102), a matching service (104), a channel interface engine (106), a job application service (108), an analytics database (110), a application database (112), a jobs database (114), a user database (116), and an analytics engine (118). Each of these components is described below.

In one embodiment of the invention, each client (100) corresponds to a remote system configured to interface with the service front-end (102). The client may be a mobile device (e.g., smart phone tablet computer, laptop, etc.) or any non-mobile computer device (e.g., desktop, etc.) with functionality to interface with the service front-end (102). Such functionality may include, but is not limited to, a web browser or standalone application along with hardware and/or software necessary to communicate with the service front-end.

In one embodiment of the invention, the service front-end (102) includes functionality to interface with the clients (100) and the matching service (104) (described below). In one embodiment of the invention, the service front-end is implemented as a web-server configured to serve web pages to the client and to receive input from the client via the client's web browser and/or a standalone application on the client. In one embodiment of the invention, if the client is executing a web browser to interface with the service front-end, then the service front-end includes the web pages to send to the client(s). Upon receipt of input from the client, the service front-end is configured to extract and, if necessary, modify the input, prior to sending the input to the matching service (104) (described below). Similarly, upon receipt of data from the matching service (104), the service front-end is configured to perform the required formatting of such data, prior to sending the formatted data to the client(s). In one embodiment of the invention, the service front-end may interact with multiple clients simultaneously.

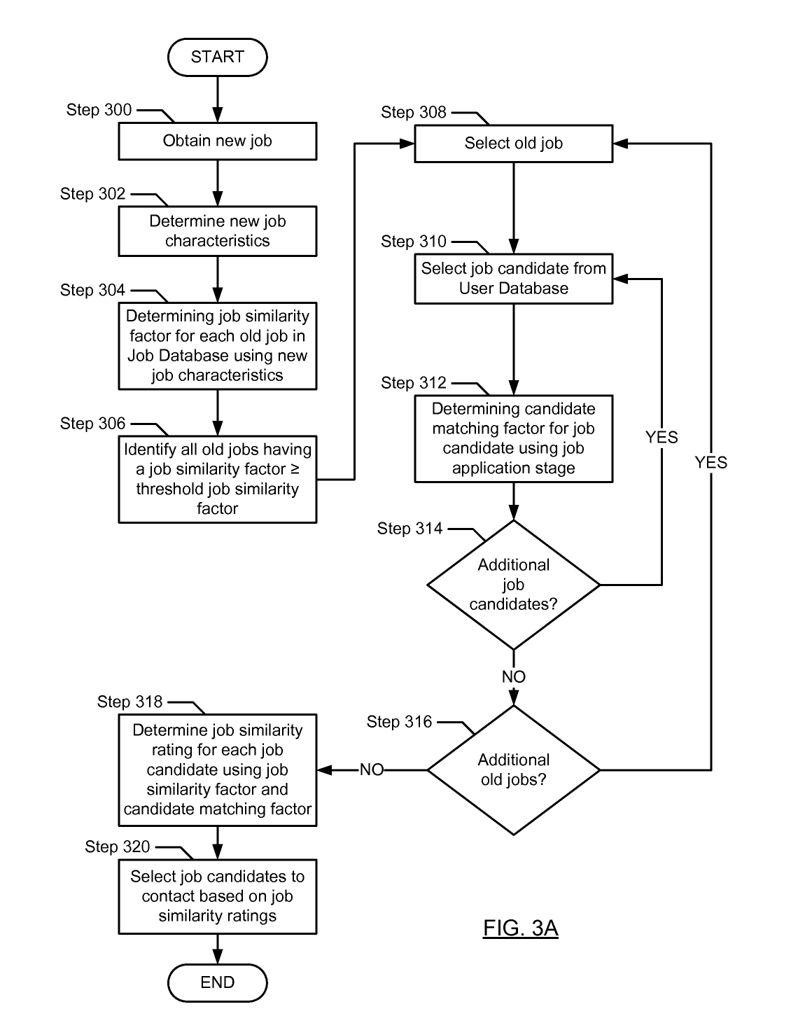

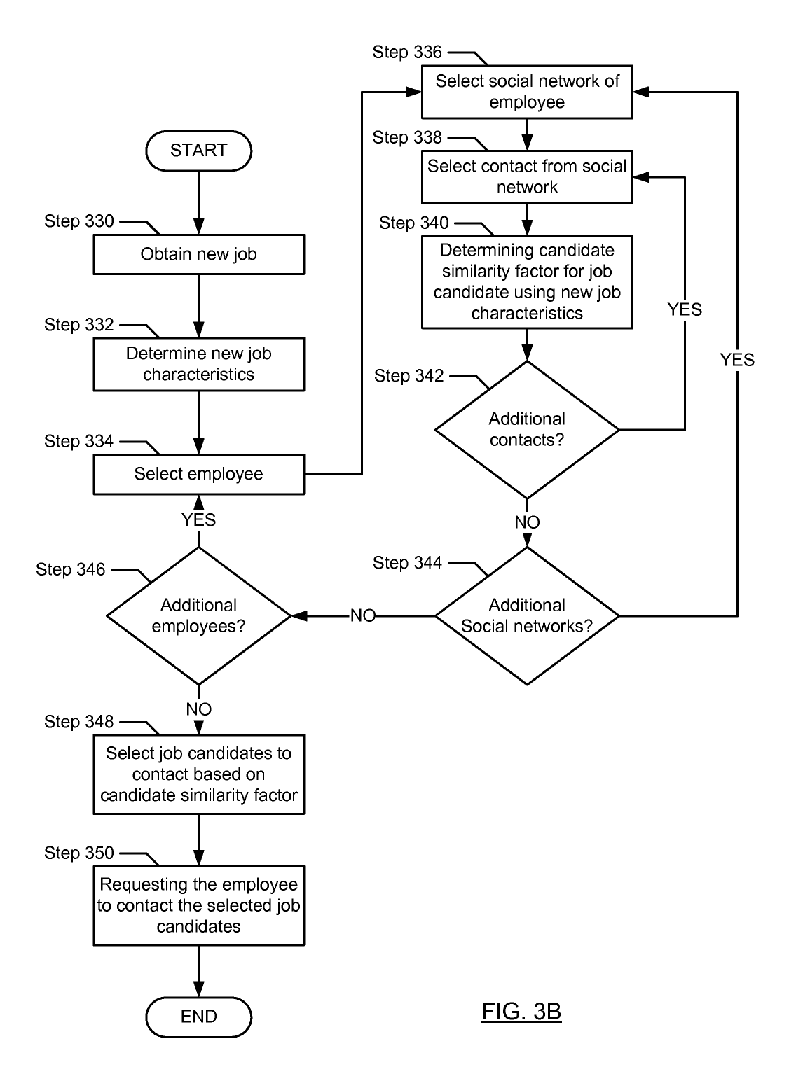

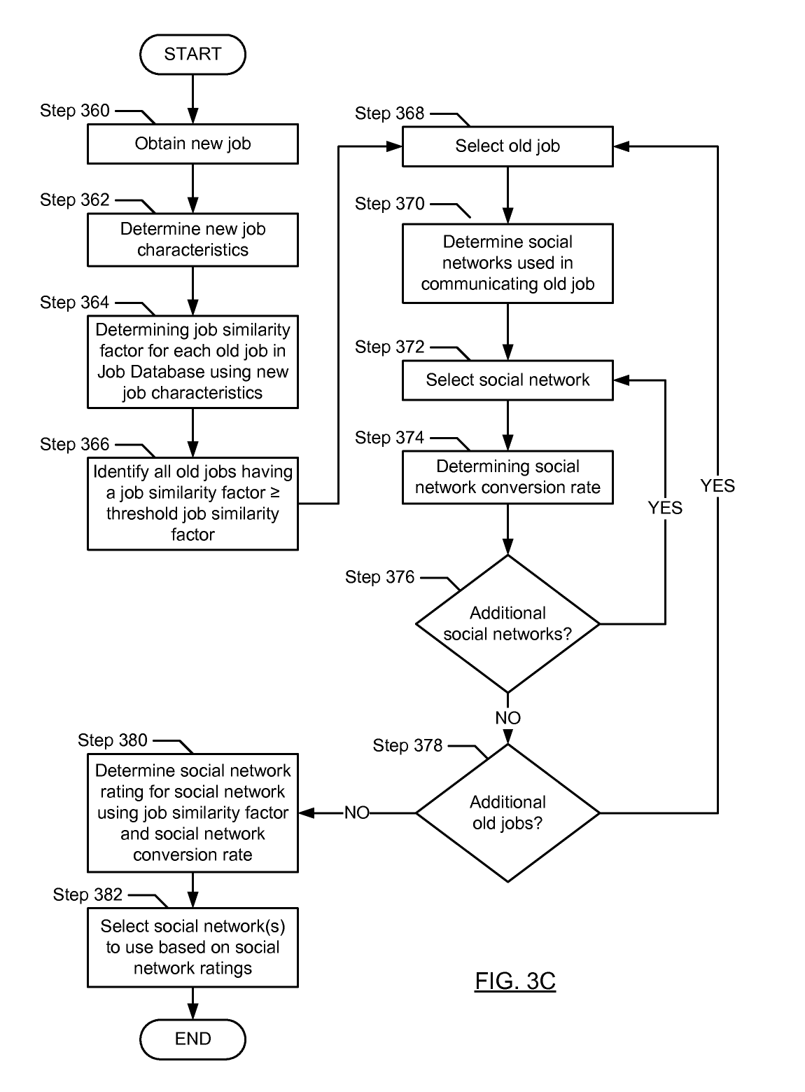

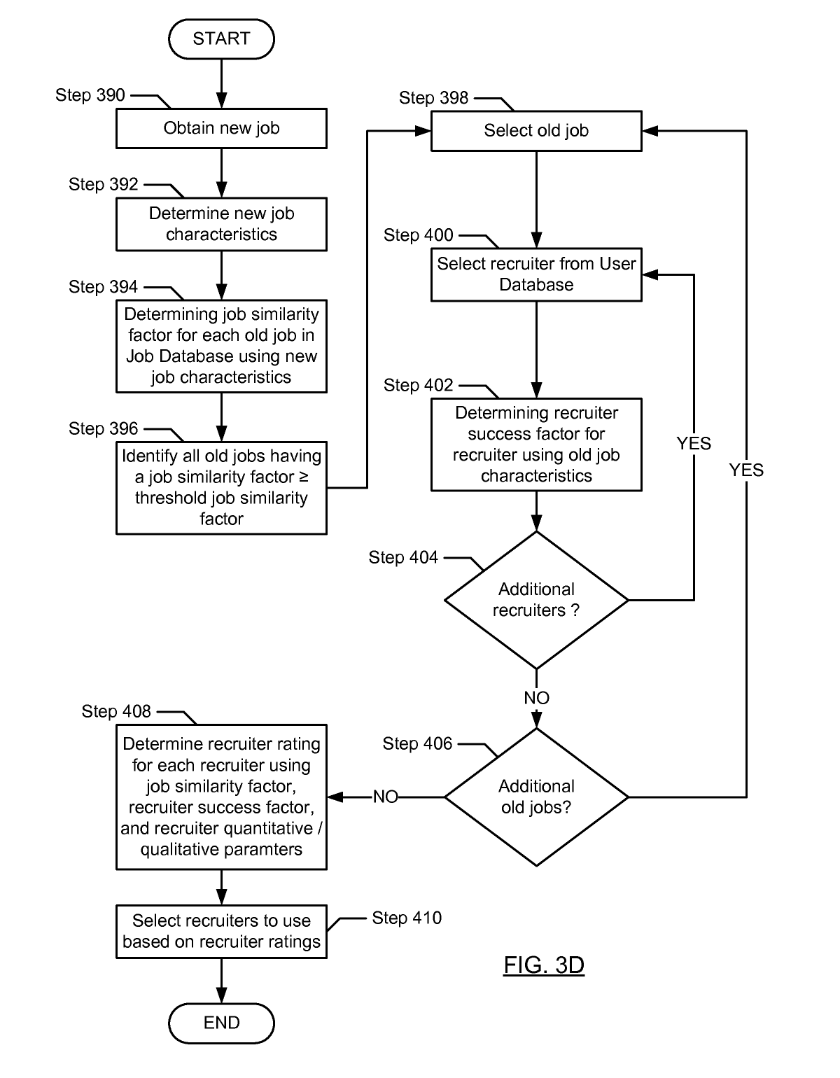

In one embodiment of the invention, the matching service (104) is configured identify job candidates (122), referral entities (124), and/or social networks (not shown) that match a particular job using one or more methods shown in FIGS. 3A-3D. Once a particular job candidate, referral entity or social network is identified, the matching service (or another service, which may not be shown in FIG. 1) may create job messages or broadcast job messages (as appropriate). Once created, the matching service (or another service, which may not be shown in FIG. 1) forwards the job messages and/or broadcast job messages to the channel interface engine (106). In one embodiment of the invention, the channel interface engine (106) includes functionality to send or otherwise communicate the job message or broadcast job message on the communication channel specified in the job message or broadcast job message.

In one embodiment of the invention, a communication channel (120A, 120N) refers to any service and/or social network that supports the communication of job messages and/or broadcast job messages to job candidates (122) or referral entities (124). Examples of services include, but are not limited to, electronic mail (e-mail), short message service (SMS), TWITTER, Craigslist, and blogs. Examples of social networks include, but are not limited to, FACEBOOK, LINKEDIN, and MYSPACE. In one embodiment of the invention, communication channels used to communicate job messages may be referred to as direct communication channels. Examples of direct communication channels may include, but are not limited to, e-mail, LINKEDIN InMail, TWITTER messages (also referred to as direct messages), and SMS. In one embodiment of the invention, communication channels that are used to communicate broadcast job messages may be referred to as broadcast communication channels. Examples of broadcast communication channels may include, but are not limited to, a blog, CRAIGSLIST, a FACEBOOK status update, a LINKEDIN update, a TWITTER status update, a FACEBOOK wall post, and a LINKEDIN group post. TWITTER is a registered trademark of Twitter, Inc. of California, U.S.A. FACEBOOK is a registered trademark of Facebook, Inc. of California, U.S.A. MYSPACE is a registered trademark of MySpace, Inc. of California, U.S.A. LINKEDIN is a registered trademark of LinkedIn, Inc. of California, U.S.A. CRAIGSLIST is a registered trademark of Craigslist, Inc. of California, U.S.A.

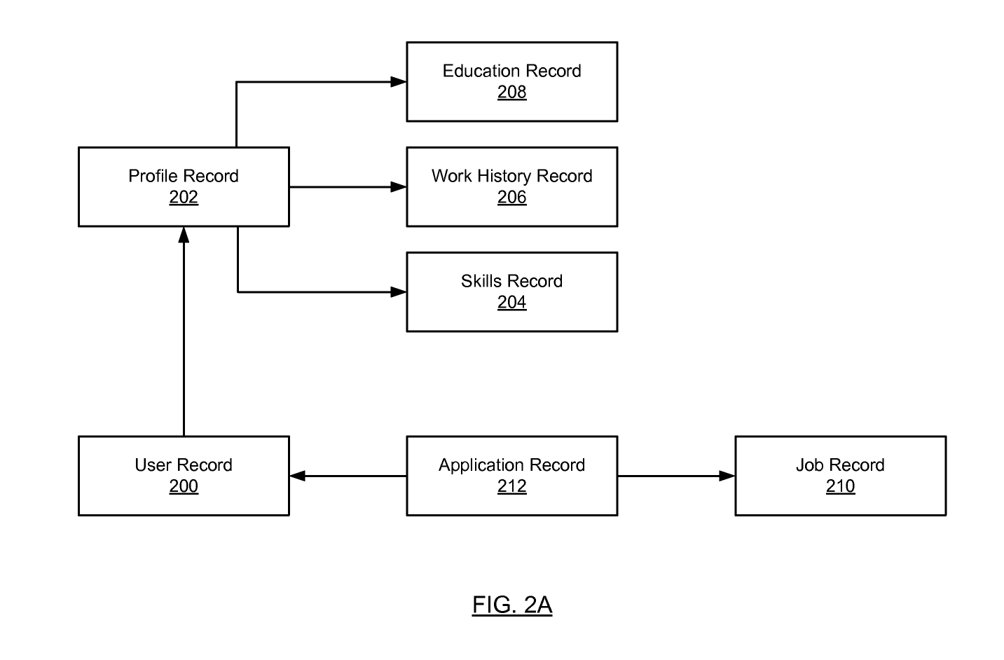

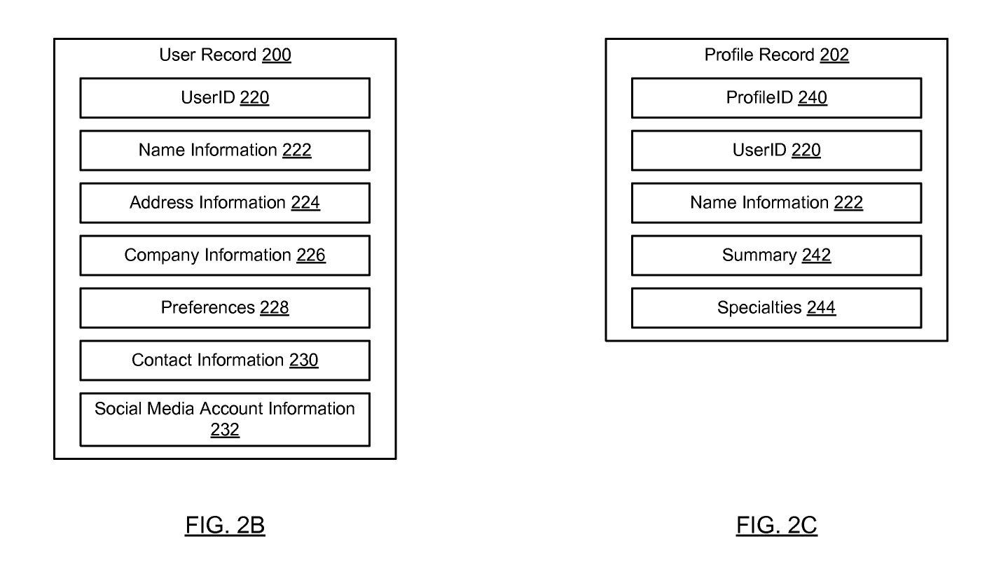

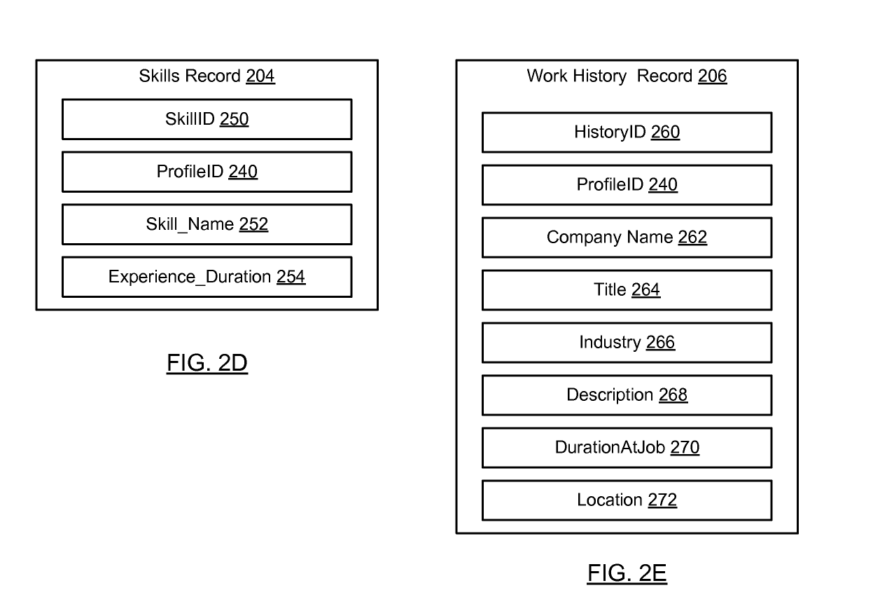

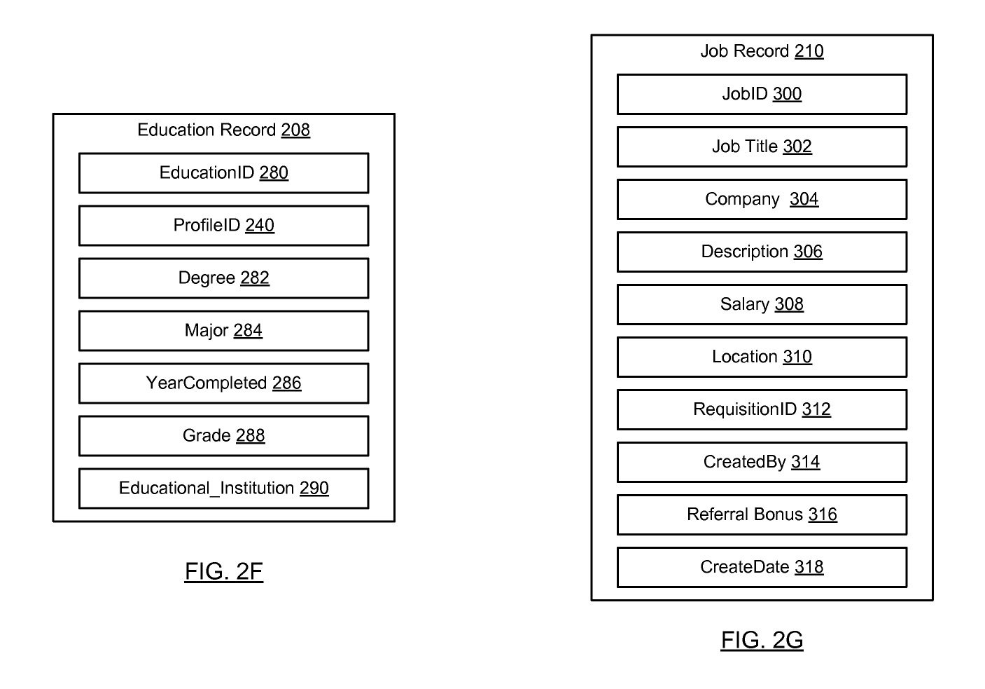

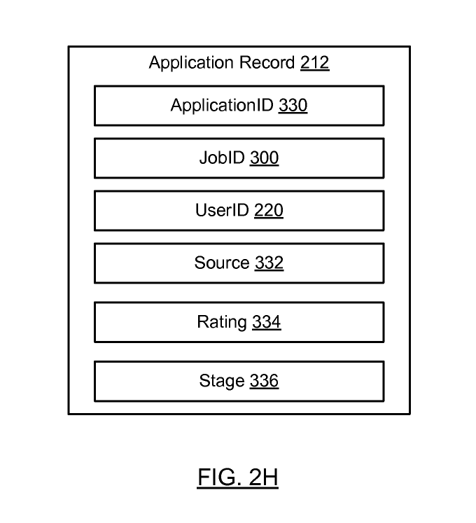

In one embodiment of the invention, the application database (112) includes application records (212). The content of the application records is described below in FIG. 2H. In one embodiment of the invention, the job database (114) includes job records (210). The contents of these records is described below in FIG. 2G. In one embodiment of the invention, the user database (118) includes user records (200), profile records (202), education records (208), work history records (206), and skills records (204). The contents of these records are described below in FIGS. 2B-2F.

In one embodiment of the invention, the analytics engine (118) includes functionality to analyze the records in the application database (112), the job database (114), and/or user database (116) to determine, for example, the effectiveness of the various communication channels used to communicate with job candidates (122) and/or the effectiveness of various referral entities (124). In one embodiment of the invention, an analytics database (110) is configured to store the results of generated by the analytics engine.

In one embodiment of the invention, the analytics database (110), the application database (112), the job database (114), and the user database (116) may be implemented using any persistent data storage device and/or technology including, but not limited to, magnetic storage, and solid state storage. Further, those skilled in the art will appreciate that the invention is not limited to the implementation shown in FIG. 1. The various components in FIG. 1 may be omitted, combined or otherwise re-configured without departing from the invention.

FIGS. 2A-2H show data structures in accordance with one or more embodiments of the invention. FIG. 2A shows the relationship between the various records in accordance with one or more embodiments of the invention. As shown in FIG. 2A, each user is associated with a user record (200). Further, each user record (200) is associated with a profile record (202). The profile record (202) is further associated with one or more education records (208), one or more work history records (206), and one or more skills records (204). In addition, each user record (200) is associated with one or more application records (212). Finally, each application record (212) is associated with one job record (210).

FIG. 2B shows a user record (200) in accordance with one or more embodiments of the invention. Each user record is associated with an individual. The individual may be a job candidate and/or a referral entity. Each user record (200) may include one or more of the following fields: (i) UserID (220) configured to store a unique numeric, alpha, or alphanumeric value to uniquely identify the user within the system; (ii) name information (222) configured to store the name of the user; (iii) address information (224) configured to store the current physical address of the user; (iv) company information (226) configured to store the company at which the user is currently employed; (v) preferences (228) configured to store various user preferences related to how the user prefers to interact with the various portions of the system (e.g., the user prefers to receive job messages and/or broadcast job messages over e-mail, etc.); (vi) contact information (230) configured to store the user's contact information, e.g., e-mail address(es), phone number, etc.; and (vii) social media account information (232) configured to store social media account information for the user, e.g., FACEBOOK username and password, TWITTER handle, etc. Those skilled in the art will appreciate that in any given user record (208) one or more of the aforementioned fields may not be completed.

FIG. 2C shows a profile record (202) in accordance with one or more embodiments of the invention. Each profile record (202) is associated with a user record (200). Each profile record (202) may include one or more of the following fields: (i) ProfileID (240) configured to store a unique numeric, alpha, or alphanumeric value to uniquely identify the profile record within the system; (ii) UserID (220) configured to store a unique numeric, alpha, or alphanumeric value to uniquely identify the user within the system; (iii) name information (222) configured to store the name of the user; (iv) summary (242) configured to store a summary of the user's education, skills, etc, where the user corresponds to the user identified in User ID (220); and (v) specialties (244) configured to store keywords use to describe the user's expertise in one or more areas. Those skilled in the art will appreciate that in any profile record one or more of the aforementioned fields may not be completed.

FIG. 2D shows a skills record (204) in accordance with one or more embodiments of the invention. Each skills record is associated with a profile record (202). Each skills record (204) may include one or more of the following fields: (i) SkillID (250) configured to store a unique numeric, alpha, or alphanumeric value to uniquely identify the skills record within the system; (ii) ProfileID (240) configured to store a unique numeric, alpha, or alphanumeric value to uniquely identify the profile record within the system; (iii) Skill_Name (252) configured to store the name (or description) of the skill; and (iv) Experience_Duration (254) configured to store the length of time that the user (i.e., the user associated with the profile record) had the skill. Those skilled in the art will appreciate that in any skill record one or more of the aforementioned fields may not be completed.

FIG. 2E shows a work history record (206) in accordance with one or more embodiments of the invention. Each work history record is associated with a profile record (202). Each work history record (206) may include one or more of the following fields: (i) HistoryID (260) configured to store a unique numeric, alpha, or alphanumeric value to uniquely identify the work history record within the system; (ii) ProfileID (240) configured to store a unique numeric, alpha, or alphanumeric value to uniquely identify the profile record within the system; (iii) company name (262) configured to store the company name at which the user (identified via the profileID) currently works or has previously worked); (iv) title (264) configured to store the job title the user held at the company; (v) industry (266) configured to store the industry in which the company operates; (vi) description (268) configured to store a description of the job (i.e., the job identified by the title (264)), where the description may include the more detailed information about job responsibilities, etc.; (vii) DurationAtJob (270) configured to store the length of time the user (identified via the profileID) was at the job (i.e., the job identified by the title (264)); and (viii) location (272) configured to store the geographic location of the job (i.e., the job identified by the title (264)). Those skilled in the art will appreciate that in any work history record one or more of the aforementioned fields may not be completed.

FIG. 2F shows an education record (208) in accordance with one or more embodiments of the invention. Each education record is associated with a profile record (202). Each education record (208) may include one or more of the following fields: (i) EducationID (280) configured to store a unique numeric, alpha, or alphanumeric value to uniquely identify the education record within the system; (ii) ProfileID (240) configured to store a unique numeric, alpha, or alphanumeric value to uniquely identify the profile record within the system; (iii) degree (282) configured to store the degree that the user (identified via the ProfileID) has obtained, e.g., Bachelor's degree, Master's degree, doctorate, etc.); (vi) major (284) configured to store information about the primary area of study for which degree was obtained; (v) YearCompleted (286) configured to store the year in which the degree was conferred; (vi) grade (288) configured to store the grade point average (GPA) or other grade information for the degree; and (vii) Educational_Institution (290) configured to store the college, university, etc. which the conferred to degree to the user. Those skilled in the art will appreciate that in any education record one or more of the aforementioned fields may not be completed.

FIG. 2G shows a job record (210) is accordance with one or more embodiments of the invention. Each job record (210) uniquely identifies a job within the system. Each job record (210) may include one or more of the following fields: (i) JobID (300) configured to store a unique numeric, alpha, or alphanumeric value to uniquely identify the job within the system; (ii) JobTitle (302) configured to store the title of the job; (iii) Company (304) configured to store the company that is offering the job; (iv) Description (306) configured to store the description of the job (e.g., education requirements, required skills, preferred skills, etc,); (v) Salary (308) configured to store the salary of the job; (vi) Location (310) configured to store the location of the job, e.g., the city, state, and/country in which the job is located; (vii) RequisitionID (312) configured to store a numeric, alpha, or alphanumeric value to uniquely identify the job from the perspective of the company offering the job; (viii) CreatedBy (314) configured to store the UserID of the user that created the job record (210); (ix) Referral Bonus (316) configured to store whether there is a referral bonus associated with the job and/or the amount of the referral bonus; and (x) CreateDate (318) configured to store the date on which the job record was created. Those skilled in the art will appreciate that in any given job record (210) one or more of the aforementioned fields may not be completed.

FIG. 2H shows an application record (212) is accordance with one or more embodiments of the invention. Each application record (212) uniquely identifies a job application within the system. Each application record (212) may include one or more of the following fields: (i) ApplicationID (330) configured to store a unique numeric, alpha, or alphanumeric value to uniquely identify the job application within the system; (ii) JobID (300) configured to store a unique numeric, alpha, or alphanumeric value to uniquely identify the job within the system, where the JobID identifies the job that is associated with the application record; (iii) UserID (220) configured to store a unique numeric, alpha, or alphanumeric value to uniquely identify the user within the system, where the userID identifies the user that applied for the job (corresponding to the JobID); (iv) source (332) is configured to store the referral entity that referred the job to the user (as identified by the UserID) or the social network over which a broadcast job message was communicated to the user, where the user applied for the job via a URL in the broadcast job message; (v) rating (334) configured to store a rating by one or more individuals at the company who have reviewed by the user's resume or have interacted with the user (e.g., during an interview); and (vi) stage (336) is configured to store the job application stage that the user has reached during the job application process for the job (identified via the JobID).

In one embodiment of the invention, the rating (334) specifies one or more of the following: (i) not rated; (ii) not qualified; (iii) under qualified; (iv) maybe; (v) good; (vi) preferred; (vii) over qualified; or (viii) not interested. Those skilled in the art will appreciate that other rating schemes may be used and that the invention is not limited to the aforementioned rating scheme.

In one embodiment of the invention, the stage (336) may specify one or more of the following: (i) applied and not interviewed, (ii) phone interview and no match, (iii) in-person interview and no match, (iv) offer declined, and (v) hired. Those skilled in the art will appreciate that other schemes may be used to describe the various job application stages and that the invention is not limited to the aforementioned scheme.

FIGS. 3A-3D show flowcharts in accordance with one or more embodiments of the invention. While the various steps in the following flowcharts are presented and described sequentially, one of ordinary skill will appreciate that some or all of the steps may be executed in different orders, may be combined, or omitted, and some or all of the steps may be executed in parallel.

FIG. 3A shows a method for identifying a job candidate(s) to contact for a new job in accordance with one or more embodiments of the invention. In Step 300, a new job is obtained. In one embodiment of the invention, the new job is obtained by selecting a job record from the jobs database. In Step 302, the characteristics of the new job are determined. In one embodiment of the invention, the characteristics of the new job may be obtained by extracting one or more job characteristics from the corresponding job record.

In Step 304, a job similarity factor for each old job in the jobs database is determined using the characteristics of the new job obtained in step 302. In one embodiment of the invention, an old job is a job that (i) has a corresponding job record in the jobs database and (ii) the job record for the old job is present in the jobs database at the time Step 304 is performed. In one embodiment of the invention, the job similarity factor quantifies the similarity between an old job and the new job. The job similarity factor may be numeric value between 0 and 1, where the larger the value the more similar the old job is to the new job.

In one embodiment of the invention, the job similarity factor is determined by (i) quantifying the similarity between characteristics in the new job with characteristics in the old job to obtain job characteristic similarity values; (ii) applying a weighting factor to each of the job characteristic similarity values to obtain weighted job characteristic similarity values; and (iii) summing the weighted job characteristic similarity values to obtain a job similarity value.

In one embodiment of the invention, job characteristics that are compared may include, but are not limited to, title, skills, education, and location. Further, the job characteristic similarity values may be numeric values between 0 and 1, where the larger the value the more similar the old job characteristics is to the corresponding new job characteristic. In one embodiment of the invention, the title is associated with the highest weighting factor. In one embodiment of the invention, the weighting factors sum to 1. Those skilled in the art will appreciate that other weighting factor schemes may be used without departing from the invention.

In one embodiment of the invention, job characteristics similarity values may be determined, for example, using known semantic similarity and/or semantic relatedness techniques. For example, the job characteristics similarity values may be determined using WordNet::Similarity, or any other computational mechanism for determining semantic similarity between words and/or phrases.

Returning to FIG. 3A, in Step 306, all old jobs with a job similarity factor greater than or equal to a threshold job similarity factor are identified. In one embodiment of the invention, the job similarity threshold is used to filter out old jobs that are not similar or not similar enough to the new job. In one embodiment of the invention, the job similarity factor is 0.5. Those skilled in the art will appreciate that other job similarity thresholds may be used without departing from the invention.

In Step 308, an old job from the old jobs identified in Step 306 is selected. In Step 310, a job candidate that applied for the old job is identified. In one embodiment of the invention, the job candidate may be identified using the application records in the applications database. In one embodiment of the invention, the job candidate may be a current employee of the company who was hired for the old job.

Continuing with FIG. 3A, in Step 312, a candidate matching factor for the job candidate is determined using the job application stage the job candidate reached in the old job. In one embodiment of the invention, the job application stage is obtained from the stage field in the corresponding application record. In one embodiment of the invention, the job application stages may include, but are not limited to, (i) applied and not interviewed, (ii) phone interview and no match, (iii) in-person interview and no match, (iv) offer declined, and (v) hired. Further, each job application stage is associated with a numeric value between 1 and 10, where 1 represents applied and not interviewed and 10 represents job candidate was hired. Those skilled in the art will appreciate that other schemes may be used to describe the various job application stages and that the invention is not limited to the aforementioned scheme.

In Step 314, a determination is made about whether there are additional job candidates. If there are additional job candidates, the process proceeds to Step 310; otherwise the process proceeds to Step 316. In Step 316, a determination is made about whether there are additional old jobs (i.e., old jobs identified in Step 306) to process. If there are additional old jobs to process, the process proceeds to Step 308; otherwise the process proceeds to Step 318. In Step 318, a job similarity rating is determined for each job candidate (i.e., candidates identified in Step 310) using the job similarity factor and the candidate matching factor. In one embodiment of the invention, the job similarity rating is obtained by multiplying the job similarity factor with the candidate matching factor to a numeric value between 0 and 10. Those skilled in the art will appreciate that other schemes for determining the job similarity rating may be used without departing from the invention.

In Step 320, one or more job candidates to contact about the new job are selected based on the job similarity ratings determined in Step 318. In one embodiment of the invention, only job candidates with a job similarity rating that is above a threshold job similarity rating are selected. In one embodiment of the invention, the threshold job similarity rating is 5. Those skilled in the art will appreciate that other threshold job similarity ratings may be used without departing from the invention.

In one embodiment of the invention, the job candidates are contacted using job messages or broadcast job messages. In one embodiment of the invention, the job candidates are contacted using job messages or broadcast job messages as described in U.S. patent application Ser. No. 13/168,665, which is hereby incorporated by referenced in its entirety.

FIG. 3B shows a method for identifying an employee to contact for a new job in accordance with one or more embodiments of the invention. In one embodiment of the invention, the method shown in FIG. 3B is used to identify employees that may be effective referral entities based the potential job candidates in their social networks.

Turning to FIG. 3B, in step 330 a new job is obtained. In one embodiment of the invention, the new job is obtained by selecting a job record from the jobs database. In Step 332, the characteristics of the new job are determined. In one embodiment of the invention, the characteristics of the new job may be obtained from the corresponding job record.

In step 334, an employee of the company that is offering the job is identified. In one embodiment of the invention, the employee may be any employee in the company. In another embodiment of the invention, the employee may be an employee with a particular job title, in a particular division, at a particular location, or any combination thereof or selected using other criteria.

In step 336, a social network of the employee is selected. In one embodiment of the invention, the social network is listed in the user record corresponding to the employee. In step 338, a contact from the identified social network is selected. In one embodiment of the invention, the information about the employee's username and password for the social network are obtained from the employee or from the user record of the employee. The matching service (or another service) communicates the employee's username and password information to the social network using an application programming interface (API) exposed by the social network. Once the social network authenticates the employee using the employee's username and password, the matching service (or another service) requests the employee's contacts from the social network (for example using an API exposed by the social network). The social network subsequently provides a listing of contacts (or optional profiles of each of the contacts) to the matching service (or related service).

Continuing with FIG. 3B, in step 340, a candidate similarity factor for the contact using the new job characteristics is selected. In one embodiment of the invention, information about the contact's work history, skills, location, education, and/or any other information used to determine the candidate similarity for the contact is obtained from contact's profile in the social network (or from a combination of the contact's profile in the social network, other information about the contact from another social network, and/or other public sources). In one embodiment of the invention, the candidate similarity factor is determined by comparing job characteristics of the new job with current/past job characteristics of jobs of the contact. The candidate similarity factor may be determined using the same method as the job similarity factor (as described in FIG. 3A, Step 304). The candidate similarity factor may be a numeric value between 0 and 1, The more similar the contact's current or past job is to the new job, the higher the value of the candidate similarity factor.

Continuing with FIG. 3B, in step 342, a determination is made about whether there are additional contacts to process in the social network identified in Step 336. If there are additional contacts to process in the social network, the process proceeds to Step 338; otherwise the process proceeds to Step 344. In step 344, a determination is made about whether there are additional social networks to process (i.e., social networks to which the employee identified in Step 334 belongs). If there are additional social networks to process, the process proceeds to Step 336; otherwise the process proceeds to Step 346. In Step 346, a determination is made about whether there are additional employees to process. If there are additional employees to process, the process proceeds to step 334; otherwise the process proceeds to Step 348.

In step 348, job candidates are selected from the contacts processed in Step 340. In one embodiment of the invention, only contacts with a candidate similarity factor above a threshold candidate similarity factor are selected. In one embodiment of the invention, the threshold candidate similarity factor is 0.5. Those skilled in the art will appreciate that other threshold candidate similarity factor may be used without departing from the invention.

In Step 350, employees associated (via their social networks) to the job candidates identified in Step 348 are contacted regarding the new job and, in certain embodiments, asked to forward the new job to various contacts within their social network(s). In one embodiment of the invention, the employees are contacted using job messages or broadcast job messages. Further, the employees may use job messages or broadcast job messages to communicate the job to the contacts within their social network(s).

In one embodiment of the invention, an employee may be identified as a referral entity if (i) the employee currently holds or has previously held a job title that is the same or similar (as determined, for example, by semantic similarity and/or semantic relatedness techniques as discussed above) to the title of the new job and/or or (ii) if the employee currently holds or has held a job in the same profession as the new job (e.g., the employee is a computer programmer and the new job is for a Software Architect). If such an employee is identified, the employee is either (i) sent a job message or broadcast job message about the new job or (ii) is sent request to communicate the job via direct and/or indirect communication channels using job messages and/or broadcast job messages.

FIG. 3C shows a method for identifying a social network over which to advertize a new job in accordance with one or more embodiments of the invention. More specifically, FIG. 3C shows a method for identifying one or more social networks that may be used to effectively communicate the new job to job candidates based on the effectiveness of the social networks to reach job candidates for old jobs.

Turning to FIG. 3C, on Step 360, a new job is obtained. In one embodiment of the invention, the new job is obtained by selecting a job record from the jobs database. In Step 362, the characteristics of the new job are determined. In one embodiment of the invention, the characteristics of the new job may be obtained from the corresponding job record.

In Step 364, a job similarity factor for each old job in the jobs database is determined using the characteristics of the new job obtained in step 362. In one embodiment of the invention, the job similarity factor is determined in the same manner as described in Step 304 in FIG. 3A.

In Step 366, all old jobs with a job similarity factor greater than or equal to a threshold job similarity factor are identified. In one embodiment of the invention, the job similarity threshold is used to filter out old jobs that are not similar or not similar enough to the new job. In one embodiment of the invention, the job similarity factor is 0.5. Those skilled in the art will appreciate that other job similarity thresholds may be used without departing from the invention.

In Step 368, an old job from the old jobs identified in Step 366 is selected. In Step 370, the social networks used to communicate the old job to potential job candidates are identified. In one embodiment of the invention, the social networks may be identified using the communication channel information included within the job messages and broadcast job messages as well as the source field in the corresponding application records (322 in FIG. 2H).

In Step 372, a social network from the social networks identified in Step 370 is selected. In step 374, the social network conversion rate is determined. In one embodiment of the invention, the social network conversion rate is the rate at which a given job candidate applies for the old job based on receiving a job message or broadcast job message via the social network. The social network conversion rate may be a numeric value between 0 and 1, where 1 indicates that 100% of the job candidates contacted via the social network applied for the old job. Those skilled in the art will appreciate that the social network conversion rate may be based on other metrics such as how far job candidates contacted via a given social network progressed in the job application process.

In one embodiment of the invention, the social network conversion rate for a given social network may be weight based on the quality of job candidates obtained via a given social network. In such embodiments of the invention, the quality of the job candidates is based on the average stage job candidates have progressed within the job applications process. The weighting factor applied to the social network conversion rate may be between 0 and 1. Those skilled in the art will appreciate that the invention is not limited to the weighting factor scheme described above.

Returning to the discussion of FIG. 3C, in Step 376, a determination is made about whether there are additional social networks (as identified in Step 370) to process. If there are additional social networks to process, the process proceeds to Step 372; otherwise the process proceeds to Step 378. In Step 378, a determination is made about whether there are old jobs (as identified in Step 366) to process. If there are additional jobs to process, the process proceeds to Step 368; otherwise the process proceeds to Step 380.

In Step 380, the social network rating for each social network (as identified in Step 372) is determined using the job similarity factor and the social network conversion rate (which may be weighted). In one embodiment of the invention, the social network rating is obtained by multiplying the job similarity factor with the social network conversion factor (or weighted social network conversion factor) to obtain a numeric value between 0 and 1. Those skilled in the art will appreciate that other schemes for determining the social network rating may be used without departing from the invention.

In Step 382, one or more social networks to use to communicate broadcast job messages are selected based on the social network ratings determined in Step 380. In one embodiment of the invention, only social networks with a social network rating that is above a threshold social network rating are selected. In one embodiment of the invention, the threshold social network rating is 0.5. Those skilled in the art will appreciate that other threshold social network ratings may be used without departing from the invention.

FIG. 3D shows a method for identifying a recruiter to use to locate candidates for a new job in accordance with one or more embodiments of the invention. More specifically, FIG. 3D shows a method for identifying one or more recruiters that may be used to effectively locate job candidates for the new job based on the effectiveness of the recruiter to locate job candidates for old jobs.

Turning to FIG. 3D, on Step 390, a new job is obtained. In one embodiment of the invention, the new job is obtained by selecting a job record from the jobs database. In Step 392, the characteristics of the new job are determined. In one embodiment of the invention, the characteristics of the new job may be obtained from the corresponding job record.

In Step 394, a job similarity factor for each old job in the jobs database is determined using the characteristics of the new job obtained in step 392. In one embodiment of the invention, the job similarity factor is determined in the same manner as described in Step 304 in FIG. 3A.

Returning to FIG. 3D, in Step 396, all old jobs with a job similarity factor greater than or equal to a threshold job similarity factor are identified. In one embodiment of the invention, the job similarity threshold is used to filter out old jobs that are not similar or not similar enough to the new job. In one embodiment of the invention, the job similarity factor is 0.5. Those skilled in the art will appreciate that other job similarity thresholds may be used without departing from the invention.

In Step 398, an old job from the old jobs identified in Step 396 is selected. In Step 400, a recruiter is selected from the user database, where the recruiter was either (i) hired to locate job candidates for the old job (as identified in Step 398) and/or (ii) referred a job candidate who applied for the old job.

In Step 402, the recruiter success factor is determined. In one embodiment of the invention, the recruiter success factor quantifies the quality of the job candidates referred by the recruiter and is based on the average stage job candidates have progressed within the job application process. The recruiter success factor may be between 0 and 10.

In another embodiment of the invention, the recruiter success factor may quantify one or more of the following: the number of job candidates the recruiter located for the old job, what sources (e.g., social networks, recruiter's database, etc.) the recruiter used to locate job candidates for the old job, job candidate feedback on the recruiter, hiring manager feedback about the recruiter, and/or overall hiring rate for the recruiter for jobs that are similar to the new job (i.e., what percentage of jobs for which the recruiter was hired did the recruiter find a job candidate who was ultimately hired for the job). Those skilled in the art will appreciate that the recruiter success factor may be a combination of any of the recruiter success factors described herein. Further, those skilled in the art will appreciate that the invention is not limited to the recruiter success factor described above.

Returning to the discussion of FIG. 3D, in Step 404, a determination is made about whether there are additional recruiters (as identified in Step 400) to process. If there are additional recruiters to process, the process proceeds to Step 400; otherwise the process proceeds to Step 406. In Step 406, a determination is made about whether there are additional old jobs (as identified in Step 396) to process. If there are additional jobs to process, the process proceeds to Step 398; otherwise the process proceeds to Step 408.

In Step 408, the recruiter rating for each recruiter (as identified in Step 400) is determined using the job similarity factor, the recruiter success factor, or optionally, recruiter quantitative parameters (e.g., recruiter's fee structure, time to locate job candidates) and/or recruiter qualitative parameters (e.g., responsiveness of recruiter to company, etc.). In one embodiment of the invention, the recruiter rating is obtained by multiplying the job similarity factor with the recruiter success factor to obtain a numeric value between 0 and 10. The recruiter rating may be further modified based on recruiter quantitative parameters and/or recruiter qualitative parameters. Those skilled in the art will appreciate that other schemes for determining the recruiter rating may be used without departing from the invention. In Step 410, one or more recruiters are selected based on the recruiter ratings.

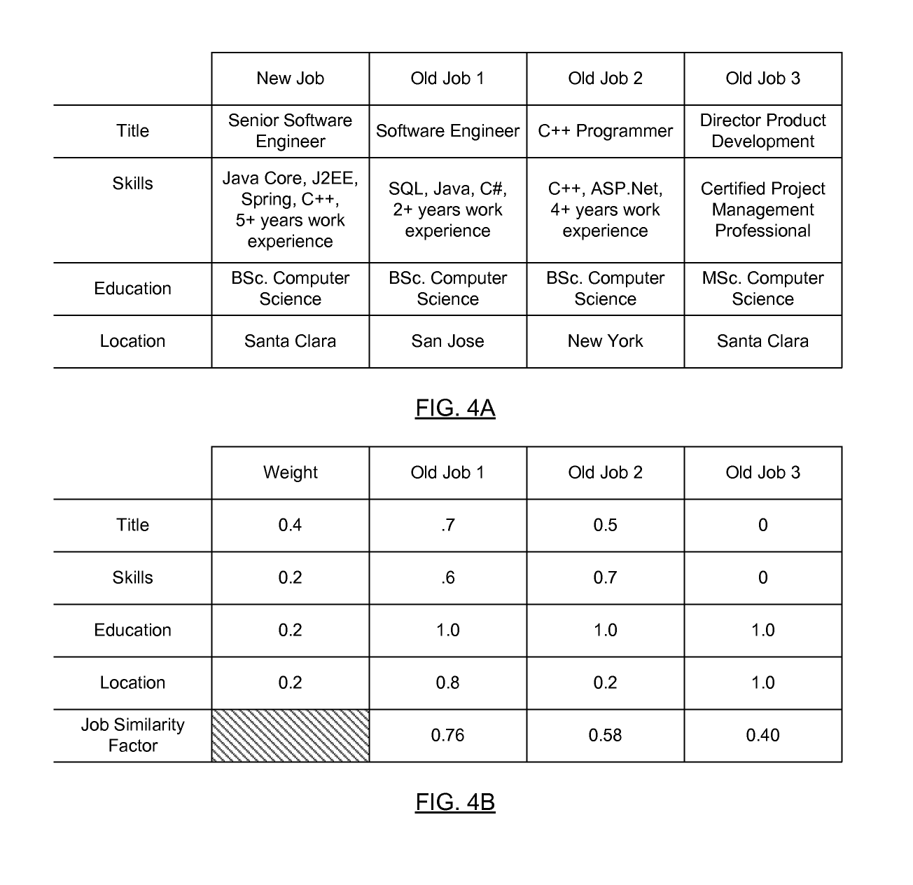

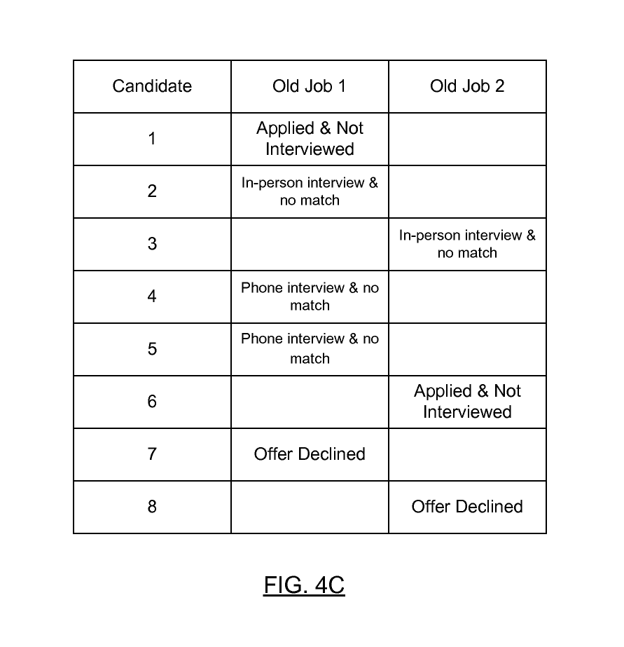

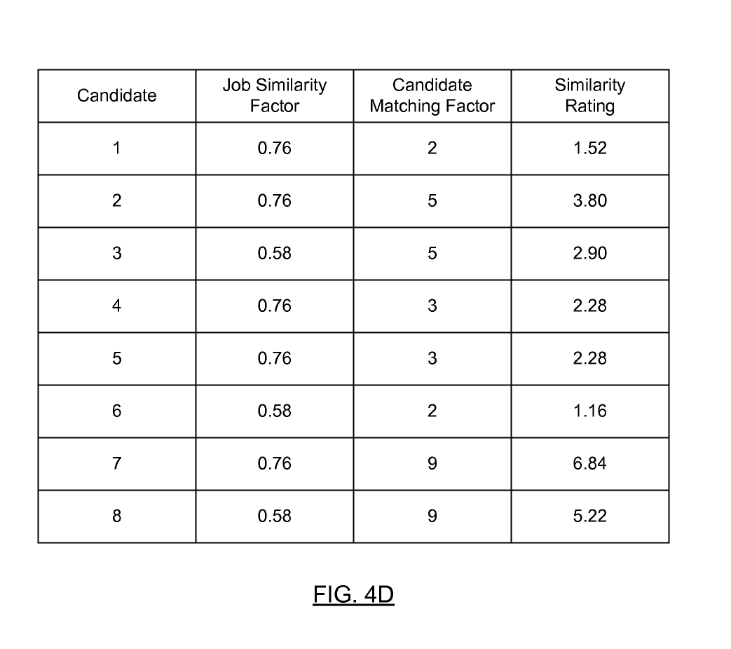

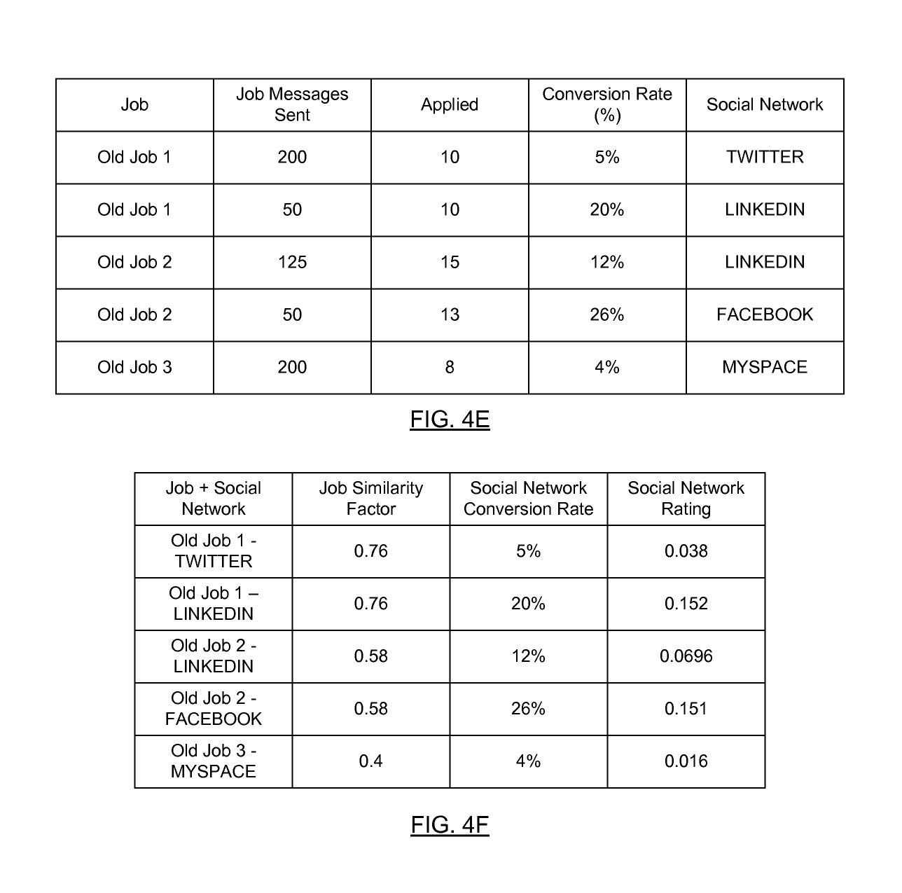

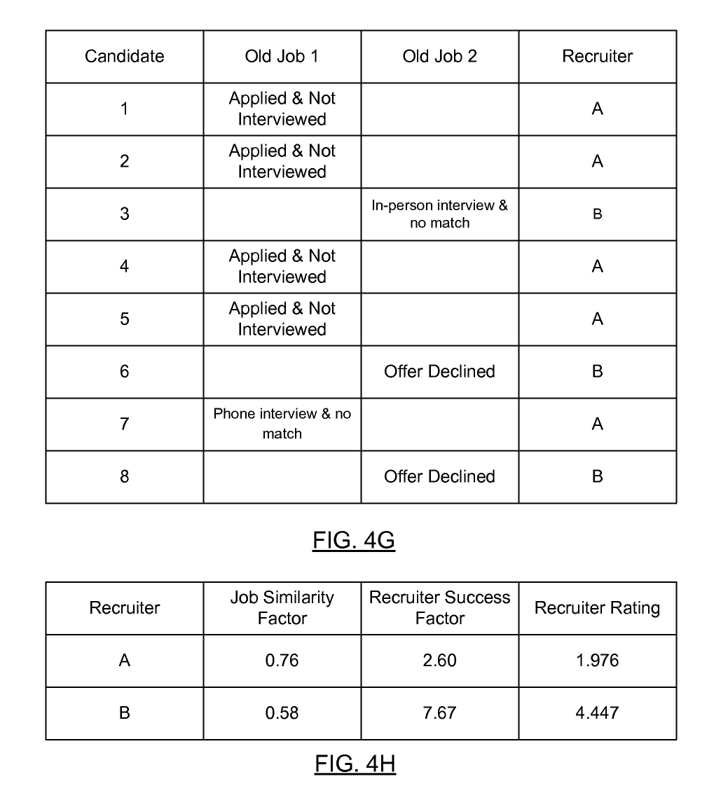

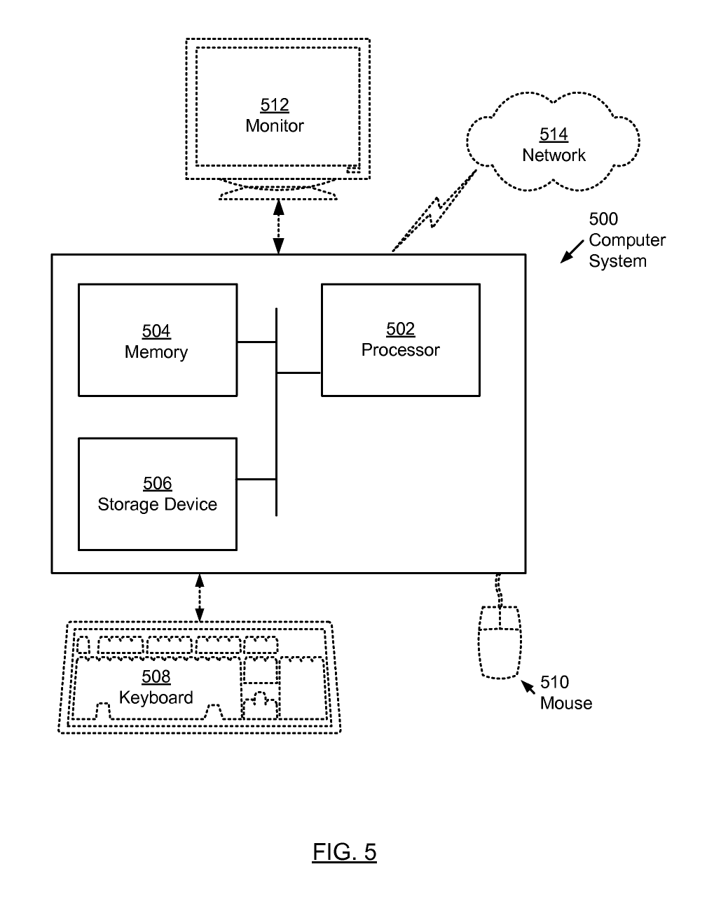

FIGS. 4A-4H describe examples in accordance with various embodiments of the invention. The examples are included for illustrative purposes only and are not intended to limit the invention.

Referring to FIG. 4A, consider a scenario in which a new job for a “Senior Software Engineer” is entered into the system. Various characteristics of the new job such as title, skills, education, and location are extracted from the corresponding job record. The new job characteristics (as shown in FIG. 4A) are compared against three old jobs (i.e., old job 1, old job 2, old job 3) in the jobs database.

Referring to FIG. 4B, the similarity between a new job characteristic and the corresponding characteristic in each of the old jobs is quantified using a value between 0 and 1, where 1 represents an exact match (or that the old job characteristics exceeds the corresponding characteristic in the new job). The resulting value may be referred to as a job characteristic similarity value. For example, the education requirement for the new job is a Bachelor's degree in computer science. Old job 3 has an educational requirement of a Master's Degree in computer science. In this scenario, because the master's degree exceeds the minimum educational requirements for the new job, the similarity for the education characteristic between the new job and old job 3 is set to 1.

In addition, as shown in FIG. 4A, each of the characteristics is weighted. Finally, the job similarity factor for old job 1 as compared with the new job is calculated as follows: Job Similarity for old job 1=(job characteristic similarity value_{Title}*0.4)+(job characteristic similarity value_{Skills}*0.2)+(job characteristic similarity value_{Education}*0.2)+(job characteristic similarity value_{Location}*0.2). Job similarity values for old jobs 2 and 3 may be calculated in a similar manner. In this example, the job similarity value for old job 1 is 0.76, old job 2 is 0.58, and old job 3 is 0.4.

Based on the job similarity values calculated for old jobs 1-3 and a job similarity threshold of 0.5, old jobs 1 and 2 are determined to be similar to the new job. Based on this determination, application records for all job candidates that applied for jobs 1 and 2 are obtained from the application database. FIG. 4C shows which candidates applied for each job and how far each job candidate progressed in the job application process on a per-job basis.

Using the information about the stage reached by each job candidate in the job application process, the candidate matching factor is determined. In one embodiment of the invention, the candidate matching factor is determined as follows:

TABLE 1
Candidate Matching Factor

| Job Application Stage | Candidate Matching Factor |
|---|---|
| Applied & Not Interviewed | 2 |
| Phone Interview & No Match | 3 |
| In-person Interview & No Match | 5 |
| Offer Declined | 9 |
| Hired | 10 |

Referring to FIG. 4D, the candidate matching factor for each job candidate is determined using Table 1 and the job application stage that the job candidate reached in the job application process. Using the job similarity factor and the candidate matching factor, the similarity rate for each job candidate may be determined. In embodiment of the invention, the similarity rating for job candidate 1 is determined as follows: (Job Similarity Factor_{Old Job 1}*Candidate Matching Factor_{Job Candidate 1-Old Job 1}). Job similarity factors for the remaining job candidates may be determined in a similar manner. Based on the similarity ratings calculated for each job candidate, candidates 7, 8, and 2 may be sent a job message or broadcast job message about the new job. The remaining job candidates may be deemed as unsuitable matches for the new job.

Referring to FIGS. 4E and 4F, consider the scenario in which TWITTER and LINKEDIN were used to communicate with job candidates for old job 1, LINKEDIN and FACEBOOK were used to communicate with job candidates for old job 2, and MYSPACE was used to communicate with job candidates for old job 3. FIG. 4E shows the conversion rates for each social network expressed as a percentage of job candidates that applied/job candidates contacted via the social network.

Referring to FIG. 4F, the social network rating is calculated for each old job-social network pair. For example, the social network rating for Old Job 2-FACEBOOK is calculated as follows: (Job Similarity Factor_{Old Job 2}*Social Network Conversion Rate Old Job 2-FACEBOOK). The social network ratings for the other old job-social network pairs may be calculated in a similar manner. Using the aforementioned social network ratings, FACEBOOK and LINKEDIN may be selected as the social networks over which to communicate with job candidates using job messages and/or broadcast job messages.

Referring to FIGS. 4G and 4H, consider a scenario in which old jobs 1 and 2 are determined to be similar to the new job (as described above in FIGS. 4A-4D). Further, assume that recruiter A referred job candidates 1, 2, 4, 6, and 7 for old job 1, and recruiter B referred job candidates 3, 6, and 8 for old job 2. Finally, assume that the job candidates reach the job application stages as shown in FIG. 4G.

Referring to FIG. 4H, the recruiting rating may be determined using the job similarity factor and the recruiter success factor. In one embodiment of the invention, the recruiter success factor for each recruiter is determined using the information in FIG. 4G and the candidate matching factor values in Table 1. As shown in FIG. 4H, the job candidates referred by recruiter A reached an average stage of 2.6 in the job application process, while job candidates referred by recruiter B reached an average stage of 7.67 in the job applications process. In one embodiment of the invention, the recruiter rating for recruiter A may be determined as follows: recruiter rating=(Job Similarity Factor_{Old Job 1})*(Recruiter Success Factor_{Recruiter A-Old Job 1}). The recruiter rating for recruiter B may be determined in a similar manner. Based on the above calculation, recruiter B may be selected as the recruiter the company hires to locate job candidates for the new job.

Embodiments of the invention may be implemented on virtually any type of computer regardless of the platform being used. For example, as shown in FIG. 5, a computer system (500) includes one or more processor(s) (502), associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer system (500) may also include input means, such as a keyboard (508), a mouse (510), or a microphone (not shown). Further, the computer (500) may include output means, such as a monitor (512) (e.g., a liquid crystal display (LCD), a plasma display, or cathode ray tube (CRT) monitor). The computer system (500) may be connected to a network (514) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention (e.g., service front-end, matching service, channel interface engine, job application service, analytics engine, and the various database shown in FIG. 1) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions to perform embodiments of the invention may be stored on a computer readable medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A non-transitory computer readable medium comprising instructions, which when executed by a process perform a method, the method comprising::
determining a plurality of new job characteristics for a new job using a job record corresponding to the new job;
identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor;
selecting a job candidate, wherein the job candidate has applied for the old job;
determining a candidate matching factor for the job candidate based on the old job;
determining a rating for the job candidate using the job similarity factor and the candidate matching factor for the job candidate; and
identifying the job candidate to contact about the job based on the rating.

2. The non-transitory computer readable medium of claim 1, the method of claim further comprising:
sending a message to the job candidate to apply for the new job based on the rating.

3. The non-transitory computer readable medium of claim 2, wherein the message is one selected from a group consisting of a job message and a broadcast job message.

4. The non-transitory computer readable medium of claim 1, wherein the new job is offered by a company and wherein the job candidate is a current employee of the company.

5. The non-transitory computer readable medium of claim 1, wherein the old job is similar to the new job when the job similarity factor associated with the old job is greater than or equal to a threshold job similarity factor.

6. The non-transitory computer readable medium of claim 1, wherein the candidate matching factor for the job candidate is determined based on a job application stage the job candidate reached on the old job.

7. The non-transitory computer readable medium of claim 6, wherein the job application stage is one selected from a group consisting of applied and not interviewed, phone interview and no match, in-person interview and no match, offer declined, and hired.

8. The non-transitory computer readable medium of claim 6, wherein the job application stage is one of a plurality of job application stages, wherein a first job application stage of the plurality of job application stages is associated with the job candidate applying for the old job and a second job application stage of the plurality of job application stages is associated with the job candidate being hired for the old job, wherein a candidate matching factor associated with the first job application stage is less than a candidate matching factor associated with a second job application stage.

9. The non-transitory computer readable medium of claim 1, wherein the job similarity factor is determined by:
assigning a job characteristic similarity value to each of the plurality of old job characteristics to obtain a plurality of job characteristic similarity values;
applying a weighting factor to each of the plurality of job characteristic similarity values to obtaining a plurality of weighted job characteristic similarity values; and
determining the job similarity factor using the plurality of weighted job characteristic similarity values.

10. The non-transitory computer readable medium of claim 9, wherein assigning the job characteristic similarity value to each of the plurality of job characteristics comprising:
determining a similarity between a new job characteristic of the plurality of new job characteristics and a corresponding old job characteristics of the plurality of old job characteristics.

11. The non-transitory computer readable medium of claim 9, wherein one of the plurality of old job characteristics is job title, wherein one of the plurality of old job characteristics is education, wherein a weighting factor for the job title is greater than the weighting factor for the education.

12. A non-transitory computer readable medium comprising instructions, which when executed by a process perform a method, the method comprising:
determining a plurality of new job characteristics for a new job using a job record corresponding to the new job;
selecting an employee of a company, wherein the new job is at the company;
selecting a social network to which the employee belongs;
identifying a job candidate, wherein the job candidate is a connected to the employee in the social network;
determining a candidate similarity factor for the job candidate using the plurality of new job characteristics and a profile of the job candidate obtained from the social network, wherein the candidate similarity factor for the job candidate quantifies similarity between the profile and the plurality of new job characteristics; and
sending a message to the employee based on the candidate similarity factor of the job candidate, wherein the message requests the employee to refer the new job to the job candidate.

13. The non-transitory computer readable medium of claim 12, wherein the social network is one selected from a group consisting of LINKEDIN, TWITTER, and FACEBOOK.

14. The non-transitory computer readable medium of claim 12, wherein the profile of the job candidate comprises education information, location information, and current job information.

15. A non-transitory computer readable medium comprising instructions, which when executed by a process perform a method, the method comprising:
determining a plurality of new job characteristics for a new job using a job record corresponding to the new job;
identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor;
selecting a recruiter, wherein the recruiter was hired to locate job candidates for the old job;
determining a recruiter success factor based on the old job;
determining a rating for the recruiter using the job similarity factor and the recruiter success factor for the recruiter; and
determining whether to hire the recruiter to locate job candidates for the new job based on the rating.

16. The non-transitory computer readable medium of claim 15, wherein the rating is further determined using a recruiter cost factor.

17. The non-transitory computer readable medium of claim 15, wherein the recruiter success factor quantifies how successful the recruiter was in locating candidates for the old job.

18. A non-transitory computer readable medium comprising instructions, which when executed by a process perform a method, the method comprising:
determining a plurality of new job characteristics for a new job using a job record corresponding to the new job;
identifying an old job using the plurality of new job characteristics and a plurality of old job characteristics, wherein the old job characteristics are obtained from a job record corresponding to the old job, wherein the old job is similar to the new job and wherein a similarity between the old job and the new job is quantified using a job similarity factor;
determining a plurality of social networks over which a message for the old job was communicated to potential job candidates, wherein the message is one selected form a group consisting of a job message and a broadcast job message;
determining a social network conversion rate for each of the plurality of social networks to obtain a plurality of social network conversion rates,
determining a rating for each of the plurality of social networks using the job similarity factor and the plurality of social network conversion rates to obtain a plurality of ratings; and
selecting at least one of the plurality of social networks over which to communicate a job message for the new job based on the plurality of ratings.

19. The non-transitory computer readable medium of claim 18, wherein the social network conversion rate for one of the plurality of social networks is based on a rate at which job candidates apply for the new job based on job messages for new job that are communicated over the one of the plurality of social networks.
